(19) United States
(12) Patent Application Publication
(10) Pub. No.: US 2009/0028379 A1
(43) Pub. Date: Jan. 29, 2009

(54) METHOD AND SYSTEM FOR IDENTIFICATION OF FIREARMS

(75) Inventors: Rene M. Belanger, Ste-Julie (CA); Daniel S. Jones, St-Lazare (CA); Sylvain Lagace, Laval (CA); Michael McLean, St-Lazare (CA); Homero A. Yasquez, Dollard-des-Ormeaux (CA)

Correspondence Address: SIDLEY AUSTIN LLP, 717 NORTH HARWOOD, SUITE 3400, DALLAS, TX, 75201, US

(73) Assignee: FORENSIC TECHNOLOGY WAI INC., Cote Saint-Luc (CA)

(21) Appl. No.: 12/056,660

(22) Filed: Mar. 27, 2008

Related U.S. Application Data
(62) Division of application No. 10/486,460, filed on Jun. 21, 2004, now abandoned.
(60) Provisional application No. 60/236,492, filed on Sep. 29, 2000.

(51) Int. Cl. F42B 35/00; G06K 9/00

(52) U.S. Cl. 382/100

(57) ABSTRACT

A system and method for identifying, test firing, marking, and imaging firearm cartridge cases and firearms for use by firearm manufactures. The system and method includes five subsystems, which work in the following sequence: a firearm serial number recognition sub-system; a cartridge case recovery sub-system; a cartridge case sorting sub-system; a cartridge case marking sub-system; and an image acquisition sub-system (108). The firearm serial number recognition sub-system (130) reads the serial number of a firearm and stores it in a database. The cartridge case recovery sub-system recovers fired cartridge cases and transports them to the sorting sub-system. The cartridge case sorting sub-system identifies the orientation of the cartridge cases and reorients them, if necessary, for marking. The cartridge case marking sub-system stamps the firearm serial numbers on the cartridge cases. The serial number is encrypted in a 2D matrix (barcode) form on the casings. The image acquisition sub-system acquires the firing pin and breech face images of a cartridge case after reading the stamped serial number on its side.

### FIELD OF THE INVENTION

The present invention relates to an examination and imaging system for fired cartridge cases, and more specifically to an examination and imaging system for use by firearms manufacturers to gather fired cartridge case identification data.

### BACKGROUND OF THE INVENTION

It is well known that fired bullets and spent cartridge cases are left with markings from the firearm from which they come. The markings left on spent cartridge cases result from forced contact between the cartridge and metal parts within the firearm, namely the firing pin and breech. Because the breech and firing pin of each individual firearm are slightly different from firearm to firearm, those of each other firearm, markings are left on each fired cartridge case (a kind of “fingerprint”) unique to each firearm. These “fingepripnts” can be and have been used to determine if two or more cartridge cases have been fired from the same firearm (handgun, rifle, or shotgun). For example, an automated process and apparatus for capturing, storing and comparing fired cartridge case images is disclosed in U.S. Pat. No. 5,654,801 and sold by Forensic Technology WAI Inc. as the IBIS® system. However, despite its success, the ability of the IBIS® system to link cartridge cases to a particular identified firearm has been limited to cases where a firearm has been recovered as evidence. Thus, there is a need for a system that obtains information on firearms before sale (and subsequent use in potential crimes) so that firearm information and evidence gathered in criminal and other investigations, such as fired cartridge cases, can be compared against and linked to particular firearms.

The present invention provides a method of comparing the markings on spent cartridge cases and identifying the particular firearms, by serial number, from which they were fired without possession of the firearm as evidence. In accordance with the present invention, firearm manufacturers will have the ability to gather firearms identification data to be employed subsequently during forensic analysis of spent cartridge cases.

### SUMMARY OF THE INVENTION

In brief, the object of the present invention is to provide firearm manufacturers with a solution for recovering, sorting, marking, and acquiring the images of spent cartridge cases during firearm test-fires and, most preferably, a system that is fully automated.

It is one object of the present invention to provide fully automated industrial cartridge casing recovery, sorting, marking, and imaging for use by firearm manufactures in an industrial environment. In a preferred embodiment, the system and method includes five sub-systems, which work in the following sequence: a firearm serial number recognition sub-system; a cartridge case recovery sub-system; a cartridge case sorting sub-system; a cartridge case marking sub-system; and an image acquisition sub-system. The firearm serial number recognition sub-system is a hardware and software sub-system that reads the serial number of a firearm and stores it in a database. The cartridge case recovery sub-system is a mechanical sub-system, which recovers the firearm's ejected cartridge cases and transports them to the sorting sub-system. The cartridge case sorting sub-system identifies the orientation of the cartridge cases and reorients them if necessary, the object being to put the cartridge cases into the correct position for marking. The cartridge case marking sub-system stamps a reference numeral related to the firearm serial numbers on the cartridge cases with a stylus. The reference number is encrypted in a 2D matrix (barcode) form on the cartridge cases. The image acquisition sub-system automatically acquires the firing pin and breech face images of a cartridge case after reading the stamped reference number on its side. This sub-system processes many cartridge cases one after another.

### BRIEF DESCRIPTION OF THE DRAWINGS

For a more complete understanding of the present invention, and for further advantages thereof, reference is now made to the following description, taken in conjunction with the accompanying drawings, in which:

FIG. 1. is a schematic illustration of the Firearm Serial Number Recognition Sub-System of the present invention.

FIG. 2 is a perspective view of the Cartridge Case Recovery Sub-System of the present invention.

FIG. 2A is a perspective view of an alternative embodiment of the Cartridge Case Recovery Sub-System of the present invention.

FIG. 3A is a cross-sectional side view of the Cartridge Case Sorting Sub-System of the present invention.

FIG. 3B is a cross-sectional view of the Cartridge Case Sorting Sub-System of the present invention.

FIG. 4 is a top view of the Cartridge Case Marking Sub-System of the present invention.

FIG. 5A is a perspective view of the image acquisition sub-system of the present invention.

FIG. 5B is a front view of the image acquisition sub-system of the present invention.

FIG. 6 is a schematic depiction of the vacuum/blowing device of the present invention.

FIG. 7A is a perspective view of the pick and place device of the present invention.

FIG. 7B is a front view of the pick and place device of the present invention.

FIG. 8 is a perspective view of a portion of the cartridge case recovery subsystem of the present invention.

FIG. 9 is a perspective view of the cartridge case decelerator device of the present invention.

### DETAILED DESCRIPTION OF THE PREFERRED EMBODIMENTS

The present invention is a novel firearms identification system that provides a solution for recovering, sorting, marking, and acquiring the images of spent cartridge cases during firearm test-fires. In the preferred embodiment of the invention hereinafter described, the system provides a fully automated cartridge case recovery, sorting, marking, and imaging for use by firearm manufacturers in an industrial environment (e.g. a firearms manufacturer's test fire range). The preferred system includes a sequence of five sub-systems as follows: a firearm serial number recognition sub-system; a cartridge case recovery sub-system; a cartridge case sorting sub-system; a cartridge case marking sub-system; and an image acquisition sub-system.

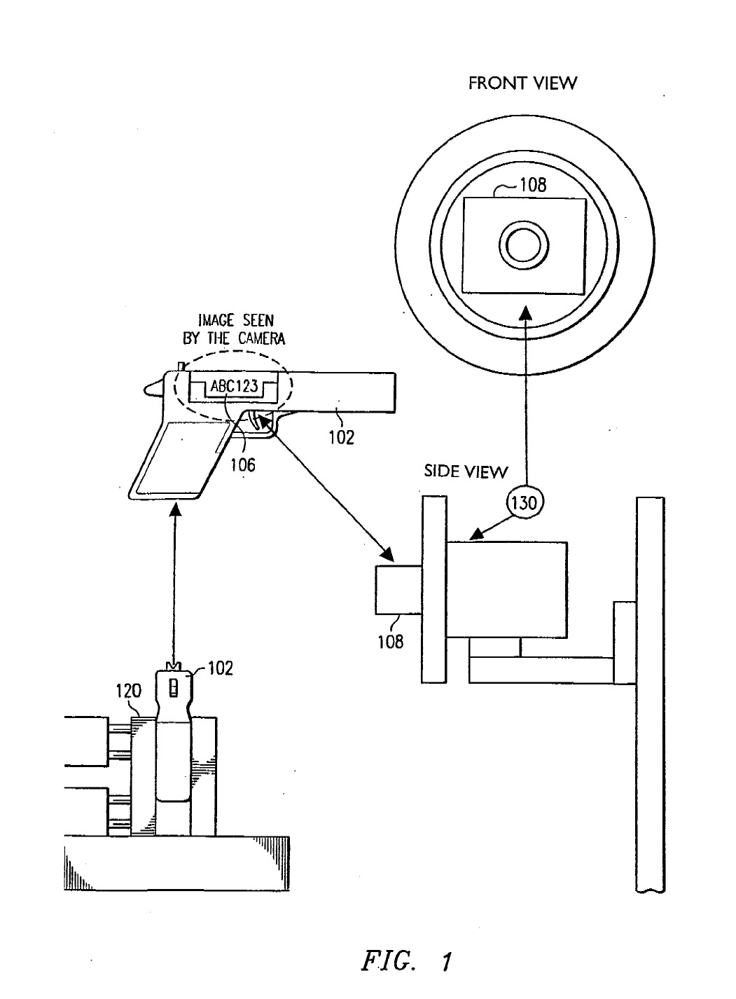

Referring to FIG. 1, the firearm serial number recognition sub-system and process shall be described. Prior to the test firing of the firearm 102, the operator positions the firearm 102 in a firearm holding fixture 120. The holding fixture 120 is a device designed to hold the firearm in place during a test fire while not obscuring the visibility of the serial number on the firearm. The firearm is positioned in the holding fixture such that its serial number 106 (or other identifying numerals, letters or markings relatively unique to the firearm, hereinafter generally referred to as a serial number) is in front of and visible to serial number recognition device 130 which is designed to automatically read the firearm serial number. In other alternative embodiment, more than one camera could be used to capture the image of the firearm serial number at different locations on the firearm.

The serial number recognition device 130 consists of a CCD (charge-coupled device) digital camera 108 connected to a computer equipped with high-resolution image grabber technology (a PCI card). A suitable image grabber is a commercially available PCI card from Matrox Inc by the name of Matrox frame Grabber Meteor 2/4. Digital camera 108 is preferably controlled by a computer which signals to the camera to take a picture (image) of the firearm serial number 106 at a preselected time prior to test firing of the firearm. This is done through OCR (Optical Character Recognition) software which instructs the frame grabber card to activate the digital camera to grab an image of the serial number on the firearm positioned in front of the camera. The image of the serial number is electronically transmitted to the computer for further processing and/or stored in the computer's memory or other storage medium (e.g. disk, storage tape, etc.) for later processing. After the image of the serial number is obtained and transmitted to the computer, the image is analyzed and processed by the computer with Optical Character Recognition (OCR) algorithm and software which are designed to read and recognize the serial number of the specific firearm. At this point in the process, the system then preferably sends the image for storage in a database and next sends the serial number (in alphanumerical format) for storage in the same database after an automatic or manual validation. The level of confidence preset in the software controlling the OCR software predefines the automatic or manual validation. The image of the serial number and the serial number itself are then linked to the record of the acquired cartridge case image for the firearm in the database. In an alternative embodiment of the firearm serial number recognition sub-system, the image capture from the CCD digital camera 108 is stored directly in the computer database and associated to the firearm serial number without being processed by the OCR algorithm.

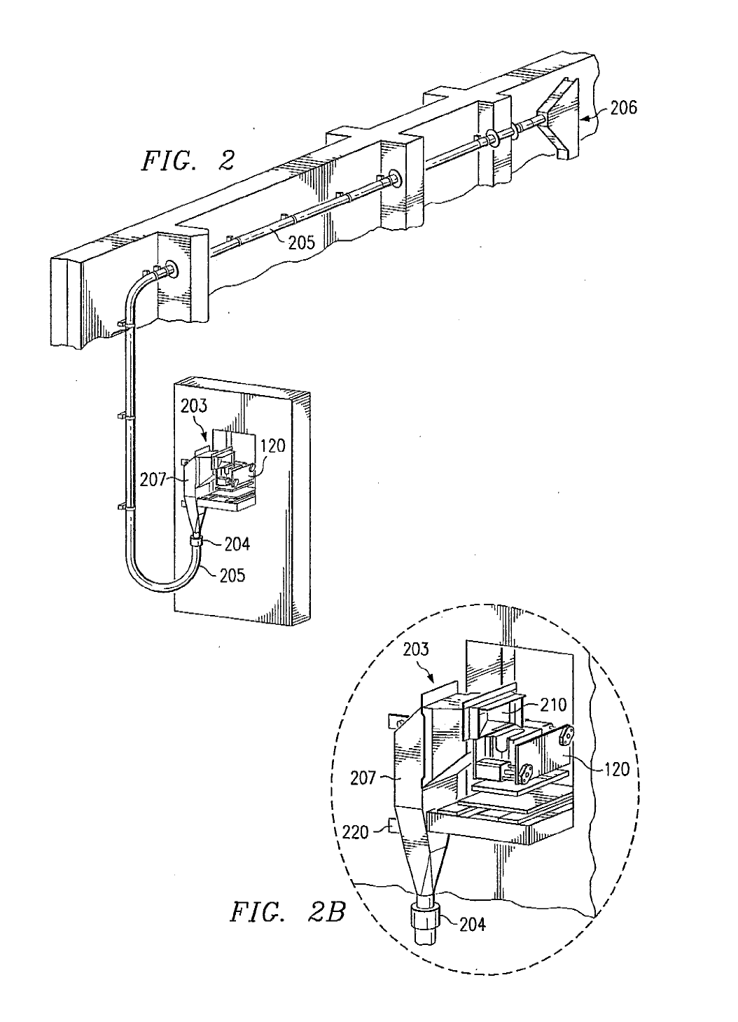

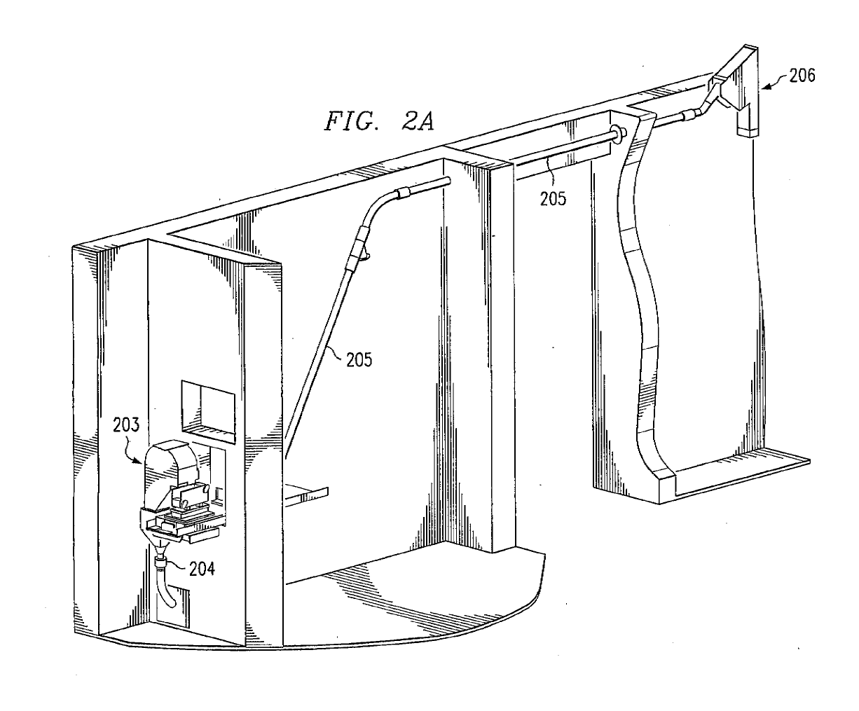

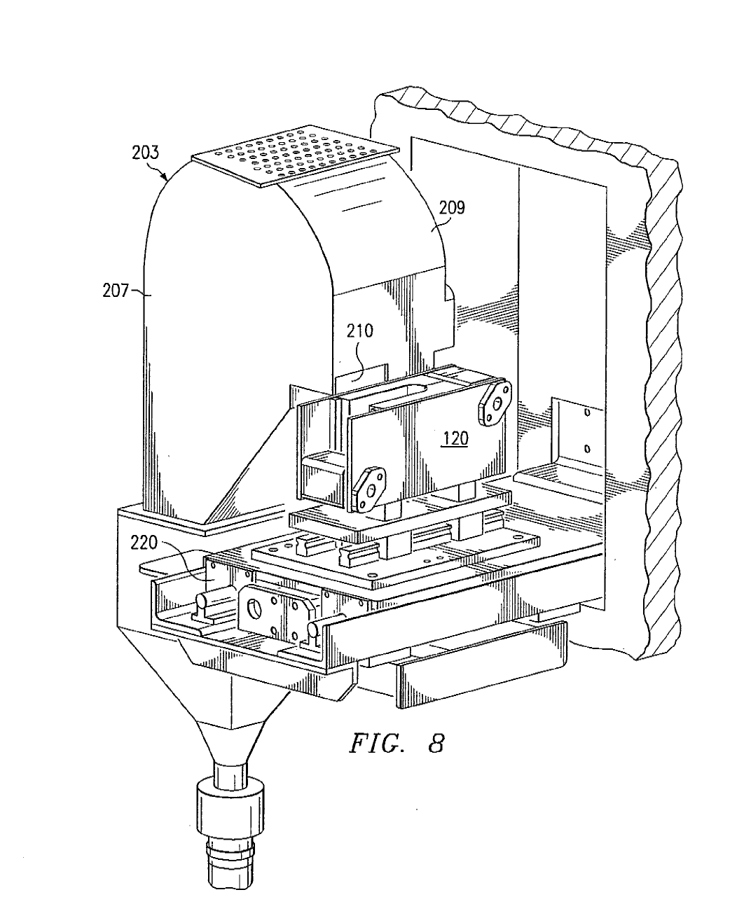

Referring to FIGS. 2 and 8, the cartridge case recovery sub-system and process will be described. The cartridge case recovery sub-system is a multi-part system that catches cartridge cases ejected from the firearm as it is test fired. As shown, a chute 203 is positioned adjacent the firearm being test fired. The chute 203 includes a main body 207 and an opening 210 designed to permit fired cartridge cases to readily enter the chute. The opening 210 is positioned in the path of the expected ejection of the spent cartridge case. The main body 207 of the chute is funnel-shaped to allow the ejected cartridge cases to fall toward a vacuuming and blowing device 204 (Venturi) and into pneumatic conveyor 205.

FIGS. 2A and 8 depict an alternative embodiment of the cartridge case recovery sub-system. The same reference numerals are used to depict similar components as described above in relation to FIG. 2. In this alternative embodiment, the orientation of conveyor 205 differs as shown. Further, in the alternative embodiment of the cartridge case recovery subsystem shown in FIGS. 2A and 8, chute 203 includes a hood portion 209 extending over the firearm held in the firearm holding jig 120. In this configuration, the chute effectively surrounds the upper part and a lateral side of the firearm and thus the ejection port of the firearm from which the fired casing is ejected.

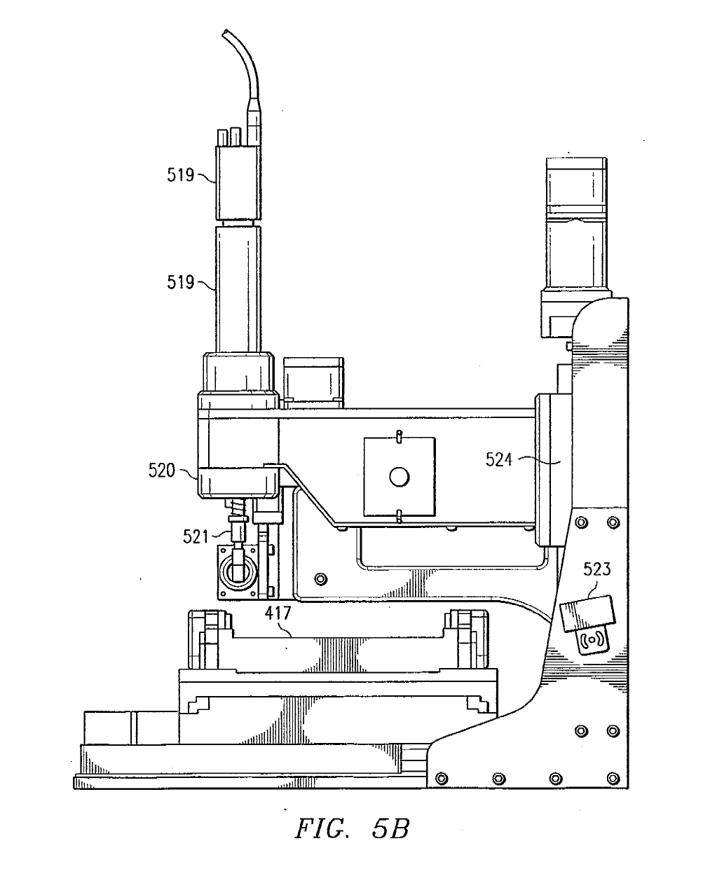

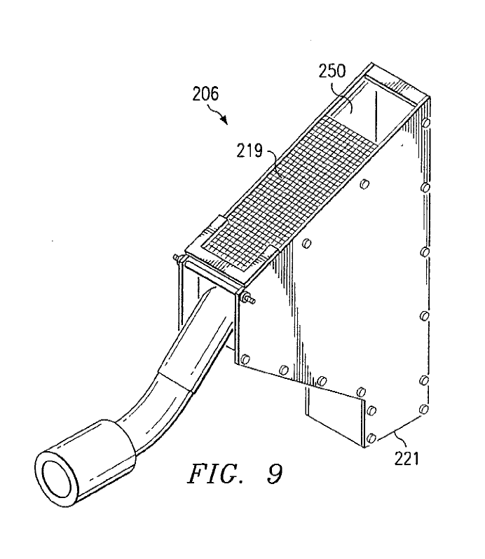

Referring to FIG. 6, the vacuum/blowing device 204 shall be described in greater detail. Vacuum device 204 is a commercially available 1½ inch diameter “venturi” (Line Vac). Compressed air flows through inlet 211 into an annular plenum chamber 213. The compressed air is then injected into the throat through directed nozzles 215. These jets of air create a vacuum at the intake 217 which draws the cartridge cases in and accelerates them through a 1¼ diameter antistatic tube 205 (pneumatic conveyor) and transports them to the end of the conveyor 205 where the cases are received by the decelerator/receiving device 206 (FIGS. 2 and 9). The antistatic tube 205 is preferably constructed of rigid plastic tubing and is made of an antistatic material to avoid build up of static electricity that can be dangerous if gunpowder builds up in the tube.

Referring to FIG. 2 and FIG. 8 (alternative configuration), after the cartridge cases are ejected into the chute 203, a light curtain device 220 counts the number of cartridge cases that go through. Light curtain devices suitable for counting cartridge cases are commercially available. The light curtain device 220 in the embodiments shown in FIGS. 2 and 8 is a commercially available Banner LS10 light curtain. Light curtain device 220 includes a light source on one side that produces a strobe array of modulated light beams to produce a light screen and receiver cell in the opposite side, creating a “light curtain” between the emitter and receiver. Preferably, the light curtain device 220 is arranged so that the light curtain is located in the middle part of the chute to ensure that all cartridge cases passing through chute 203 are counted. When a cartridge case passing through chute 203 cuts the light curtain, an electrical signal is sent to a Programmable Logic Controller (PLC) (i.e., a computer) that keeps count of cartridge cases that went through the light. Suitable PLCs are commercially available Honeywell and others. The PLC can then validate that all the cartridge cases that went through the chute arrived at the other end of tube 205 by using a second similar light curtain, where they are slowed down in the receiving device 206 (decelerator), then fall into the sorting system. The function of decelerator/receiving device 206 is to catch and reduce the traveling speed of the incoming cartridge cases and to evacuate the air and firing fumes coming from the venturi device 204. As shown in FIG. 9, decelerator/receiving device 206 has a triangular shape. The interior walls of the decelerator/receiving device 206 are covered with rubber padding 250 to avoid any extra marking on the cartridge cases. As cartridge cases enter the device with an upward trajectory, they ricochet on a mesh fabric 219 located on the upper wall of the device and then fall by gravity into a bottom opening 221, while air and firing fumes exhaust through the mesh fabric.

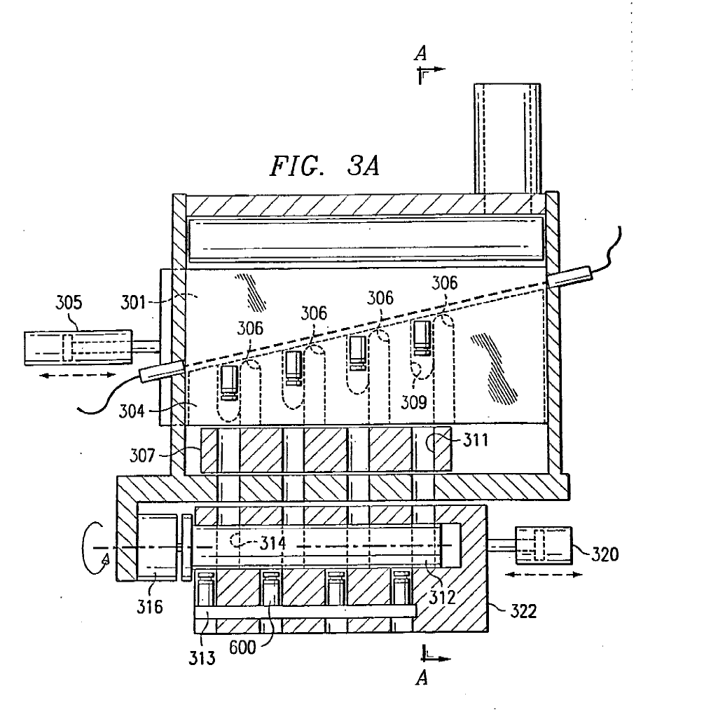

Referring to FIGS. 3A and 3B, the cartridge case sorting sub-system and process will be described. The test-fired cartridge cases 600 ejected from the firearm travel through the recovery sub-system before falling into a pre-sorting device working as a funnel comprising two parallel plates 301 and 304 and a sliding plate 302 (preferably made of plastic) at the bottom between the two parallel plates. The sliding plate 302 has four openings 309 that match the width and the length of the cartridge cases. Those openings are specially chamfered at the bottom to one side to allow the cartridge cases to slide out when the four openings 306 of the sustaining plate 304 axe properly aligned with the four casings. The top edge of the sliding plate 302 is designed with an angle to facilitate the sliding of the cartridge cases into the four openings. The sliding plate 302 moves horizontally, pushed by a pneumatic piston 305.

In the operation of the sorting sub-system shown in FIGS. 3A and 3B, the spent cartridge cases 600 are initially held vertically in slots 309 of sliding plate 302 where there are an equal number of sensors 308 relative to the number of test-fired cartridge cases. The sensors 308 detect and count the cartridge cases. Sensors 308 can be of any suitable type for detecting objects of the nature and for the purposes described herein. Model PTB 46U fiber optic sensors manufactured by Banner have been found to be particularly suitable. The PLC receives a signal from each of the four sensors 308 located beside the cartridge cases openings. When the presence of all four cartridge cases has been detected, the PLC then instructs a solenoid valve to activate pneumatic cylinder 305, which is operably connected to and moves sliding plate 302, thus guiding the four cartridge cases to fall by gravity in their respective slots 306 of plate 304. Thereafter, the released cartridge cases fall through openings 311 in transfer block 307. After a specified delay, the PLC instructs a solenoid valve to activate a pneumatic cylinder 303 that shifts the transfer block 307 over the openings of the rotating device 312.

The rotating device 312 comprises a cylinder with four chambers 314 to hold each of the respective cartridge cases 600 and is mounted to a pneumatic rotary actuator 316 driven by a solenoid valve that is controlled by the PLC and a pneumatic piston 320 for translation displacements. Once the transfer block 307 is positioned above the rotating device, the cartridge cases fall through four openings to reach the rotating device's chambers 314. At this stage, four vacuum cups 319 that axe mounted on a linear pneumatic slide 321 pick up the primer side up cartridge cases and leave any casings that have not been oriented primer side up. The remaining cartridge cases (i.e., the cases that were not oriented primer side up and therefore not picked up by the vacuum cups) are then rotated 180 degrees so that their primer side is facing up. This rotation of the rotating device 312 is performed by rotary actuator 316. The vacuum cups 319 then reposition the previously extracted cartridge cases into the empty chambers 314 of the rotating device. At that point, the orientation of all the cartridge cases is the same (primer side up) and pneumatic piston 320 moves laterally the housing block 322 (that holds the rotating device) to align the openings of the rotating device 314, with openings 318. In the next step, gate 313, moved by a pneumatic cylinder 323 that is driven by a solenoid valve, releases the cartridge cases 600 to the cartridge case marking subsystem only when the four sensors 325 confirm to the PLC the presence of four cartridge cases. Sensors 325 can be of the same type as sensors 308, namely, fiber optic sensors.

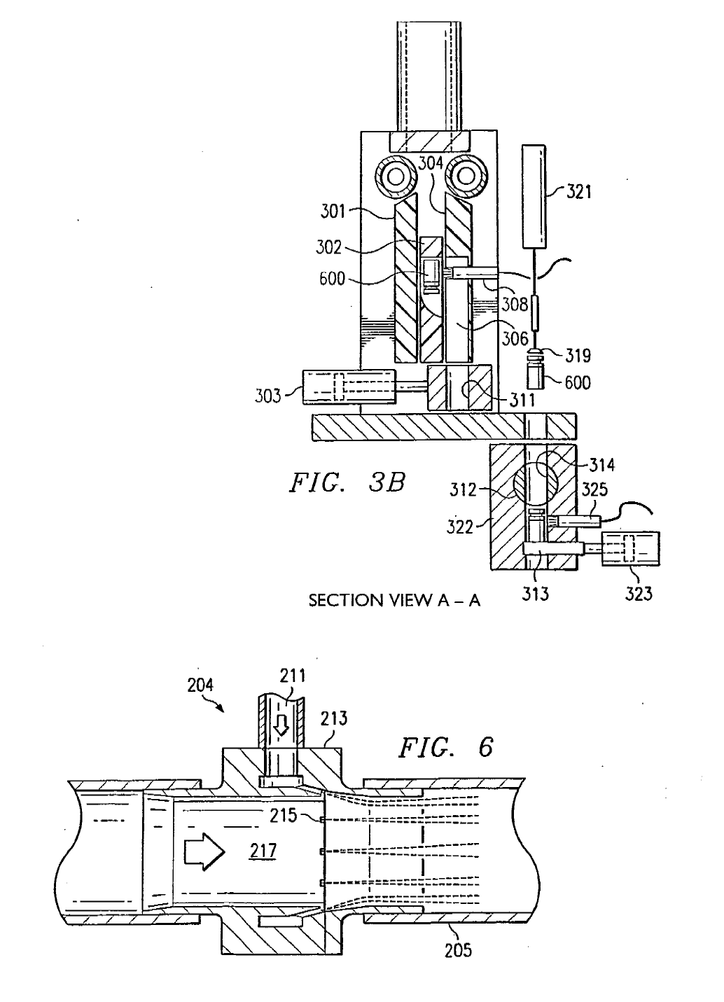

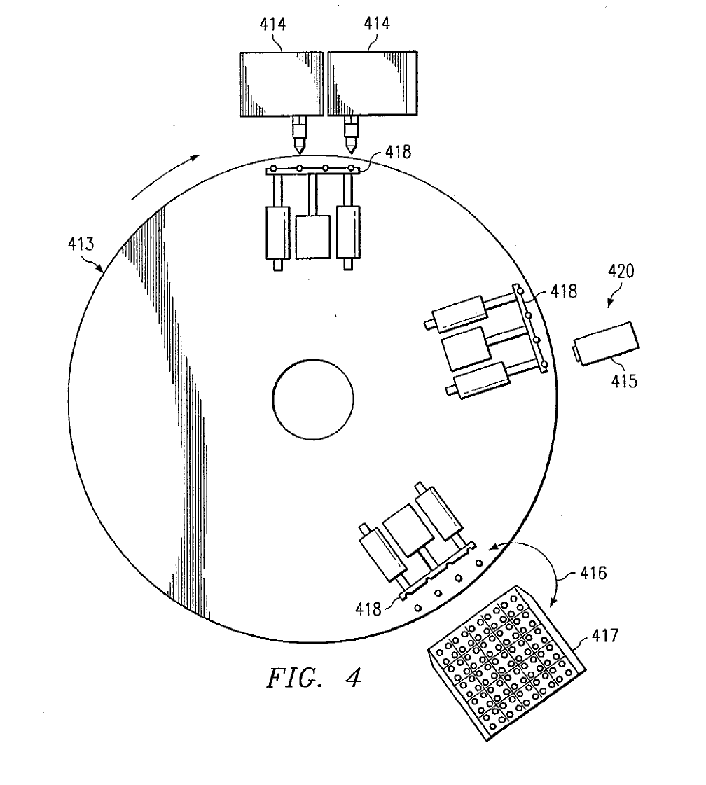

Referring to FIG. 4, the cartridge case marking sub-system and process will be described. Once all the casings are oriented correctly as described above, they fall into an indexing device 413 where they are held in place by a holding device 418, preferably working as clamps. Holding device 418 is spring loaded so that spring force is applied by default to hold the cartridge cases in place. The spring holding force is released when necessary by using a single action pneumatic cylinder, driven by a solenoid valve, which is controlled by the PLC. The indexing device 413, controlled by the PLC, positions the cartridge cases in front of the two marking machines 414. These marking machines utilize micro punching technology which uses pneumatically accelerated hardened pins to print a reference numeral linked to the serial number of the firearm. This reference number is encoded in a 2D matrix (bar code equivalent). A suitable micro punching system is the PINSTAMP® TMP 1700/400 sold by Telesis which is pneumatically driven and which uses conical tipped pins to permanently indent the surface of the cartridge cases to form a dot matrix 2D code corresponding to the firearm's serial number.

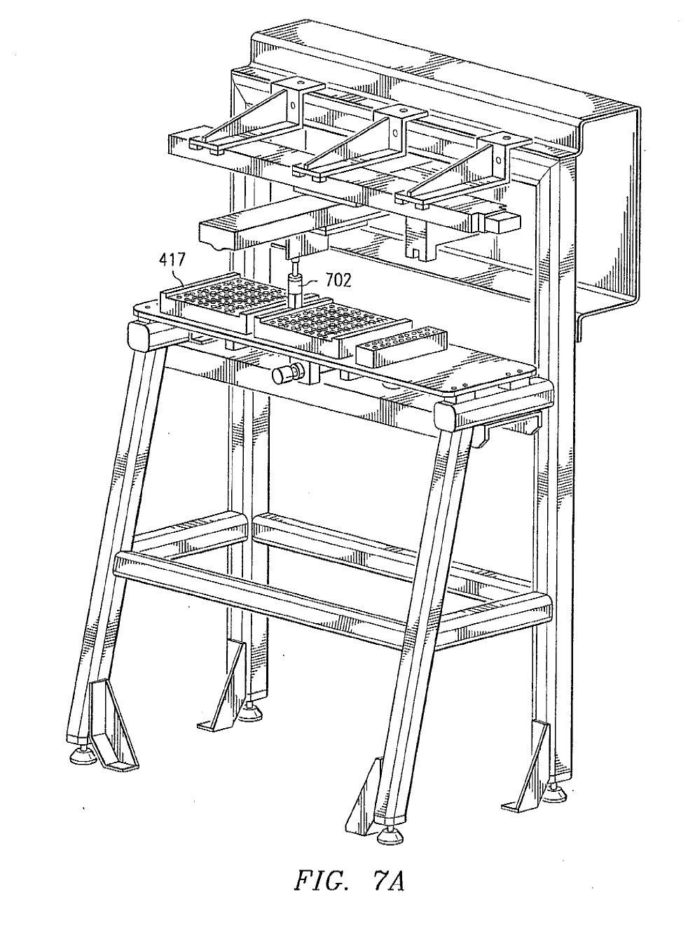

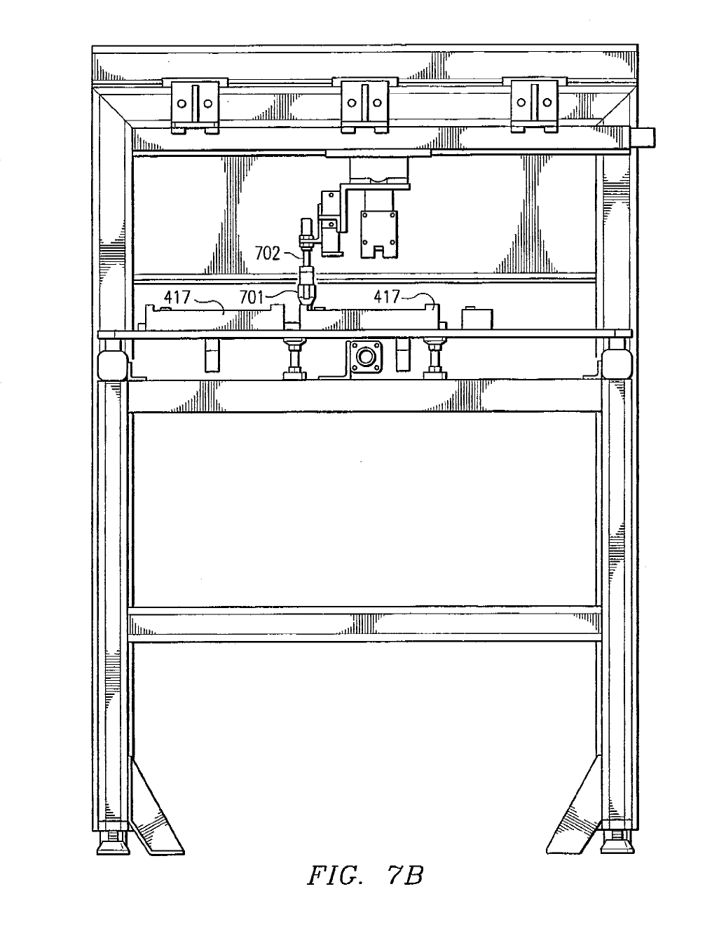

In the preferred sub-system, two machines are used at the same time to speed up the marking step. Once the cartridge cases have been marked, a vision system 420 with a CCD, (Charge Coupled Device) camera 415 reads the 2D-matrix code to validate if each cartridge case has been clearly marked for marking validation purposes. The vision system 420 uses a commercially available CCD (e.g., SmartSensor Series 600 manufactured by DVT) which includes software to read for validation purposes that the marking of the 2D bar code on the cartridge case has been properly done. After this validation process, the indexing device/table positions the cartridge cases holding device 418 in front of a pick and place device (FIGS. 7A and 7B). The cartridge cases are then picked from the storage tray 417, one at a time, by a pneumatic parallel gripper 701, moved up the Z axis 702 using a guided linear pneumatic slide and then placed in their assigned position in the storage device/tray 417. An electrical actuator drives the linear positioning of the NY table. The electrical actuators are driven by solenoid valves and the positioning tables are driven by a motion control drive and controller. As shown in FIG. 4, cartridge case storage device 417 is preferably designed to hold many cartridge cases at the same time (e.g., 100 cases as shown in FIG. 4).

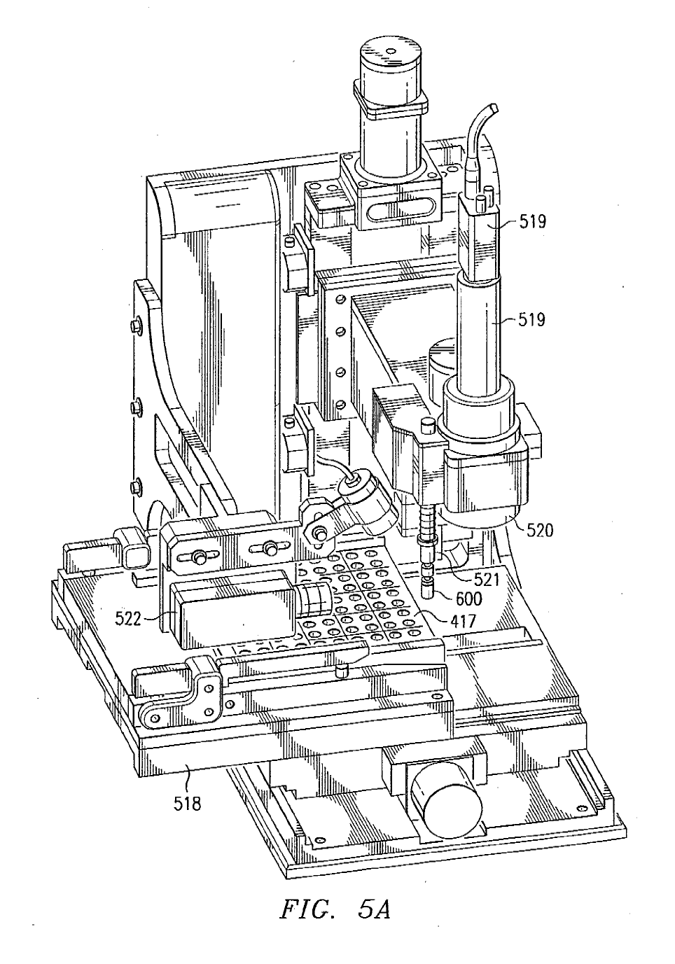

Referring to FIG. 5, the cartridge case image acquisition sub-system and process will be described. The cartridge case image acquisition sub-system is a multi-part system that includes an XY table 518 and a motorized Z axis 524; a microscope and CCD camera 519; an integrated ring light in a microscope holder 520; a motor device and vacuum cup to lift and rotate the cartridge cases 600; a 2D matrix reading system to read the cartridge case numbers 522; and a spent cartridge case storage device 417 that can contain many cartridge cases at the same time (called the carrier media). A suitable ring light 520 is available from Nikon with a Dolan-Jenner power supply.

The sorted and marked cartridge cases are positioned into a carrier media 417. This carrier media is placed manually on the motorized XY table 518 under the microscope 519 for the image acquisitions. Preferably, an automated acquisition procedure is then started, controlled by a computer. The bar code reader 523 identifies the current carrier media by reading a bar coded label attached to its side. The NY table moves sequentially to pre-programmed positions that match the cartridge case locations in the carrier device. The XY table's translations to a position under the microscope for image acquisition, the microscope's focus and the light intensity can be accomplished manually, but automated control of these steps via a computer is preferred. A small motor with a vacuum cup 521 lifts and rotates the first cartridge case in front of the digital camera (smart sensor) 522. That camera 522, assisted by lighting, reads the reference number represented by a 2D-matrix code engraved on the cartridge case. A suitable light for reading the 2D bar code is one that brings contrast to the 2D matrix code engraved on the cartridge case's surface. A commercially available light suitable for this purpose is an LED illuminator sold under the name NERLITE® S-40. The reference number that has now been read is used to validate that the correct cartridge case is being acquired.

Preferably, the acquisition of the firing pin and breech face images is done automatically with the help of a ring light 520. The process of cartridge case breech face and firing pin marks examination has been successfully automated using apparatus as set out in U.S. Pat. No. 5,654,801, which is hereby incorporated by reference. After the first image acquisition (firing pin and breech face), the next cartridge case is positioned under the microscope 519 (preferably automatically via control by a computer) and the acquisition procedure is repeated. The system continues the automatic reference number reading and the image acquisition for all the cartridge cases in the carrier media 417. Once all the cartridge cases images of the carrier media have been acquired the operator validates the images by verifying that every image corresponds to the quality required by the QA (quality assurance) standards. This can be accomplished by a visual inspection of the images by the operator who validates whether the images appear in focus and the light intensity seems adequate. Preferably this is done using a monitor with multiviewer window capability, such as that employed in the commercially available IBIS system sold by Forensic Technology WAI, Inc. of Canada, to allow a more efficient validation process. The multiviewer is a window generated by a software application displaying multiple acquired images on a monitor. Preferably, the multiviewer process employs a tiling (configurable) format, such as that employed by the IBIS system, enabling the operator to perform a fast quality assurance verification of the images. Any image that does not meet the quality standards is reacquired until quality standards are met.

After the acquisition and validation procedures are successfully executed, the acquired cartridge cases can then be used in a correlation procedure. The correlation procedure is to compare a discovered or tested-fired cartridge case against the database of images acquired as described above. Any suitable image comparison software can be used to correlate the images. A suitable correlation process is described in U.S. Pat. No. 5,654,801

Preferably, the carrier media with the cartridge cases is covered with a protective plastic plate for storage after image acquisition. The carrier media are also identified by specific barcode. The barcode stored in the database helps to trace the cartridge cases for later use in investigations or other evidentiary purposes. For example, the test fired cartridge cases may be compared under a comparison microscope with evidence from crime scenes to validate “hits” (i.e., potential matches) indicated by the automated image correlation process.

Although the present invention has been described with respect to preferred embodiments, various changes, substitutions and modifications of this invention may be suggested to one skilled in the art, and it is intended that the present invention encompass such changes, substitutions and modifications as fall within the scope of the appended claims.

1.-4. (canceled)

5. A firearms identification system comprising:
a firearm serial number recognition subsystem comprising a means to acquire an image of a serial number displayed on a firearm;
a cartridge case recovery subsystem comprising (a) a chute into which a cartridge case is deposited after said cartridge case is fired from a firearm, and (b) a fired cartridge case counting device that counts each said cartridge case passing through said chute;
a cartridge case marking subsystem comprising a means to mark said cartridge case with a reference numeral associated with said firearm serial number;
a cartridge case marking subsystem comprising a means to mark said cartridge case with a reference numeral associated with said firearm serial number;
a cartridge case imaging subsystem comprising an imaging device to capture an image of the breech face of said fired cartridge case; and
a computer to store and link said image of said breech face and said image of said firearm serial number.

6. A method of identifying firearms comprising:
test firing firearm to produce a fired cartridge case, said firearm having a serial number;
recovering said fired cartridge case;
acquiring an image of a breech face on said test fired cartridge case;
storing said breech face image; and
linking said breech face image with said firearm serial number in a database.

7. A method of identifying firearms comprising:
acquiring an image of a serial number displayed on a firearm;
storing said serial number image;
acquiring an image of a breech face on a cartridge case fired from said firearm;
storing said breech face image; and
linking said serial number image with said breech face image in a database.

8. The method of claim 6 further comprising:
acquiring an image of a serial number displayed on said firearm; and storing said serial number image.

9. The method of claim 8 further comprising:
linking said serial image with said breech face image in said database.

10. The method of claim 6, 8, or 9 wherein said step of recovering said cartridge case includes the counting of said fired cartridge case.

11. The method of claim 6, 8, or 9 wherein said step of storing said breech face image includes the use of an electronic storage medium.

12. The method of claim 6, 8, or 9 wherein said database is maintained in an electronic storage medium.

13. The method of claim 6, 8, or 9 further comprising:
marking said cartridge case with a reference numeral associated with said firearm serial number.
